(19) United States
(12) Patent Application Publication
(10) Pub. No.: US 2024/0351524 A1
(43) Pub. Date: Oct. 24, 2024

(54) VEHICLE VISUAL RECOGNITION APPARATUS

(71) Applicant: KABUSHIKI KAISHA TOKAI-RIKA-DENKI-SEISAKUSHO, Niwa-gun, Aichi-ken (JP)

(72) Inventors: Toshinari NAKAI, Aichi (JP); Keigo TADA, Aichi (JP)

(21) Appl. No.: 18/685,470

(22) PCT Filed: Jul. 4, 2022
(86) PCT No.: PCT/JP2022/026622

§ 371 Date: Feb. 21, 2024

(30) Foreign Application Priority Data
Aug. 24, 2021 (JP) 2021-136228

(51) Int. Cl. B60R 1/26; B60R 1/25

(52) U.S. Cl. CPC B60R 1/26; B60R 1/25; B60R 2300/105; B60R 2300/108; B60R 2300/303; B60R 2300/8066

(57) ABSTRACT

In a vehicle visual recognition apparatus, an image capturing unit includes a rear camera that outputs a first captured image obtained by capturing an image of the rear of a vehicle, and a side camera that outputs a second captured image obtained by capturing an image of the rear side of the vehicle from the side of a vehicle body such that a part of an image capturing region of the side camera overlaps an image capturing region of a first image capturing means. An image boundary is set in an overlapping region between the first captured image and the second captured image, a first display image is extracted from the first captured image, and a second display image is extracted from the second captured image. An image of a following vehicle of the vehicle, which is included in the first captured image, is detected. A rear image obtained by joining the first display image and the second display image is displayed on a monitor to be visible to an occupant such that the image of the following vehicle is disposed in the first display image.

### CROSS-REFERENCE TO RELATED APPLICATIONS

The present application is related and has right of priority to JP 2021-136228, which was filed on Aug. 24, 2021 in the Japanese Patent Office, and is a U.S. national phase entry of PCT/JP2022/026622, which was filed on Jul. 4, 2022, both of which are incorporated by reference in their entireties for all purposes.

### Technical Field

The technology of the present disclosure relates to a vehicle visual recognition apparatus that assists visual recognition for an occupant.

### Background Art

Japanese Patent Application Laid-Open (JP-A) No. 2019-110492 discloses a vehicle display device that trims each of a rear image, a left rear-side image, and a right rear-side image captured by a rear camera, a left rear-side camera, and a right rear-side camera to have a predetermined angle of view and displays a combined image obtained by combining the trimmed images, on a display in a vehicle interior.

In the vehicle display device, in a case in which a following vehicle located behind the vehicle is detected by a following vehicle sensor, an inter-vehicle distance from the following vehicle is determined, and an angle of view of the rear image is set to an enlarged angle of view as the inter-vehicle distance decreases, whereby a proportion of a region occupied by the rear image in the combined image is made to increase.

### SUMMARY OF INVENTION

### Technical Problem

Incidentally, in a case in which the proportion of the rear image is set to be larger than the ratios of the left side image and the right side image in the combined image displayed on the display, a blind spot located immediately behind the vehicle body of a host vehicle on the right and left becomes large. The size of the image of the following vehicle in the combined image depends not only on the inter-vehicle distance but also on the size of the following vehicle (the size in a vehicle width direction). Therefore, in a case in which the proportion of the rear image in the combined image is determined in accordance with the inter-vehicle distance from the following vehicle, the blind spot on the left and right rear sides of the host vehicle becomes large, or the combined image is displayed in a state where the image of the following vehicle is omitted, which affects the appearance of the image and the visibility to the rear of the vehicle.

The technique of the disclosure has been made in view of the above circumstances, and an object thereof is to provide a vehicle visual recognition apparatus capable of assisting visual recognition of an occupant while suppressing deterioration in visibility to a following vehicle.

### Solution to Problem

To achieve the above object, according to a first aspect, a vehicle visual recognition apparatus includes an image capturing unit that includes a first image capturing means for outputting a first captured image obtained by capturing an image of a rear of a vehicle and a second image capturing means for outputting a second captured image obtained by capturing an image of the rear side of the vehicle from a side of a vehicle body such that a part of an image capturing region of the second image capturing means overlaps an image capturing region of the first image capturing means, a display unit that sets, as a boundary, an image boundary set in an overlapping region between the first captured image and the second captured image, extracts a first display image from the first captured image and a second display image from the second captured image, in accordance with the image boundary, and displays a rear image obtained by joining the first display image and the second display image on a display medium so that the rear image is visible to an occupant, a target detection means for detecting an image of a following vehicle of the vehicle, which is included in the first captured image, and a setting means for setting the image boundary in accordance with an image position of the following vehicle such that the image of the following vehicle detected by the target detection means is disposed in the first display image.

In the vehicle visual recognition apparatus according to a second aspect, in the first aspect, the target detection means detects the following vehicle from the first captured image and the second captured image.

In the vehicle visual recognition apparatus according to a third aspect, in the first or second aspect, the setting means changes a position of the image boundary in a case in which a proportion of an image size of the following vehicle on the first display image in the rear image to an image size of the following vehicle on the first captured image is equal to or less than a proportion set in advance.

In the vehicle visual recognition apparatus according to a fourth aspect, in the first or second aspect, the setting means changes a position of the image boundary to move to a predetermined position outward in a vehicle width direction in a case in which a distance between the image of the following vehicle and the image boundary on the rear image is equal to or less than a first distance.

In the vehicle visual recognition apparatus according to a fifth aspect, in any one of the first to fourth aspects, the setting means changes a position of the image boundary to move outward in a vehicle width direction by an amount set in advance in a case in which the position of the image boundary is moved.

In the vehicle visual recognition apparatus according to a sixth aspect, in any one of the first to fifth aspects, the setting means changes a position of the image boundary to a standard position set in advance in the overlapping region in a case in which the image of the following vehicle is not detected on the first captured image.

In the vehicle visual recognition apparatus according to a seventh aspect, in any one of the first to sixth aspects, the setting means changes a position of the image boundary to approach a standard position set in advance in the overlapping region in a case in which a distance between the image of the following vehicle and the image boundary is more than a second distance set in advance.

In the vehicle visual recognition apparatus according to an eighth aspect, in any one of the first to seventh aspects, the setting means changes the position of the image boundary to be on an inner side in a vehicle width direction by an amount set in advance.

### Advantageous Effects of Invention

In the vehicle visual recognition apparatus according to the first aspect of the disclosure, the first image capturing means of the image capturing unit outputs the first captured image obtained by capturing an image of the rear of the vehicle, and the second image capturing means outputs the second captured image obtained by capturing an image of the rear side of the vehicle from a side of the vehicle such that a part of an image capturing region of the second image capturing means overlaps an image capturing region of the first image capturing means. The display unit extracts the first display image from the first captured image and the second display image from the second captured image, in accordance with the image boundary set in the overlapping region between the first captured image and the second captured image, and displays the rear image obtained by joining the first display image and the second display image at the image boundary, on the display medium to be visible to an occupant.

The vehicle visual recognition apparatus includes the setting means that sets the image boundary in accordance with the image position of the rear vehicle such that the image of the following vehicle detected by the target detection means is disposed in the first display image.

Here, the target detection means detects the following vehicle and detects the image of the following vehicle included in the first captured image. The setting means sets the image boundary such that the detected image of the following vehicle is disposed in the first display image, in a case in which the image boundary is set in the overlapping region between the first captured image and the second captured image.

As a result, in the rear image displayed on the display medium, it is possible to suppress overlapping of the image boundary with the image of the following vehicle that is traveling immediately behind the host vehicle and is displayed on the first display image, and thus, it is possible to assist the visual recognition of an occupant while suppressing deterioration in the visibility to the following vehicle.

In the vehicle visual recognition apparatus according to the second aspect, the target detection means detects the following vehicle from the first captured image and the second captured image. As a result, it is possible to effectively detect the following vehicle that travels behind the host vehicle and to effectively assist the visual recognition of the occupant.

In the vehicle visual recognition apparatus according to the third aspect, the position of the image boundary is changed in a case in which the proportion of the image size of the following vehicle on the first display image in the rear image to the image size of the following vehicle on the first captured image is equal to or less than the proportion set in advance. As a result, it is possible to effectively suppress deterioration in visibility due to a large omission of the following vehicle displayed in the rear image.

In the vehicle visual recognition apparatus according to the fourth aspect, the position of the image boundary is moved to a predetermined position outward in the vehicle width direction in a case in which the distance between the image of the following vehicle on the rear image and the image boundary is equal to or less than the first distance. As a result, it is possible to effectively suppress the deterioration in the visibility to the following vehicle.

In the vehicle visual recognition apparatus according to the fifth aspect, the position of the image boundary is changed to move outward in the vehicle width direction by the amount set in advance in a case in which the position of the image boundary is moved. As a result, in a case in which overlapping of the image boundary with the image of the following vehicle is suppressed, it is possible to suppress a large movement of the position of the image boundary, to suppress a large change of a blind spot occurring near a vehicle body, and to further effectively assist the visual recognition of the rear of the vehicle by the occupant.

In the vehicle visual recognition apparatus according to the sixth aspect, the standard position for the position of the image boundary is set in the overlapping region. The setting means changes the position of the image boundary to the standard position in a case in which the image of the following vehicle is not extracted from the first captured image. As a result, it is possible to suppress a situation in which the position of the image boundary remains moved outward from the standard position in the vehicle width direction even though the following vehicle is not detected immediately behind the host vehicle, and it is possible to suppress an occurrence of the blind spot near the vehicle body.

In the vehicle visual recognition apparatus according to the seventh aspect, the position of the image boundary is changed to approach the standard position set in advance in a case in which the distance between the image of the following vehicle and the image boundary is more than a second distance set in advance. As a result, in a case in which the distance between the image of the following vehicle and the image boundary is far away due to separation of the following vehicle from the host vehicle or the like, it is possible to suppress remaining of a situation in which the position of the image boundary is separated from the standard position. In addition, it is possible to effectively suppress the occurrence of the blind spot near the vehicle body.

In the vehicle visual recognition apparatus according to the eighth aspect, the position of the image boundary is changed to move inward in the vehicle width direction by an amount set in advance. As a result, in a case in which the distance between the image of the following vehicle and the image boundary is far away, it is possible to effectively move the image boundary. Thus, it is possible to effectively suppress the occurrence of the blind spot near the vehicle body and to effectively assist the visual recognition of the occupant.

### BRIEF DESCRIPTION OF DRAWINGS

FIG. 1 is a schematic configuration diagram of a vehicle visual recognition apparatus according to the present embodiment.

FIG. 2 is a plan view schematically illustrating a vehicle in a top view.

FIG. 3 is a schematic view schematically illustrating a captured image and a display image of a monitor.

FIG. 4A is a flowchart illustrating an example of a display process.

FIG. 4B is a flowchart illustrating an example of a boundary setting process.

FIG. 5A is a schematic view illustrating an example of display of a following vehicle (part 1), and FIGS. 5A, 5B, 5C, and 5D illustrate the following vehicle that becomes closer in this order.

FIG. 5B is a schematic view illustrating an example of display of the following vehicle (part 2).

FIG. 5C is a schematic view illustrating an example of display of the following vehicle (part 3).

FIG. 5D is a schematic view illustrating an example of display of the following vehicle (part 4).

FIG. 6 is a flowchart illustrating an example of a boundary setting process according to a modification example.

FIG. 7A is a schematic view illustrating an example of display of a following vehicle that travels in the same lane as a host vehicle and following vehicles that travel in adjacent lanes (part 1), and FIGS. 7A, 7B, 7C, and 7D illustrate the following vehicles in the adjacent lanes, which becomes closer in this order.

FIG. 7B is a schematic view illustrating an example of display of the following vehicle that travels in the same lane as the host vehicle and the following vehicles that travel in the adjacent lanes (part 2).

FIG. 7C is a schematic view illustrating an example of display of the following vehicle that travels in the same lane as the host vehicle and the following vehicles that travel in the adjacent lanes (part 3).

FIG. 7D is a schematic view illustrating an example of display of the following vehicle that travels in the same lane as the host vehicle and the following vehicles that travel in the adjacent lanes (part 4).

FIG. 8A is a schematic view illustrating an example of display of a following vehicle that travels in the same lane as a host vehicle and following vehicles that travel in adjacent lanes (part 1), and FIGS. 8A, 8B, 8C, and 8D illustrate the following vehicles in the adjacent lanes, which becomes farther in this order.

FIG. 8B is a schematic view illustrating an example of display of the following vehicle that travels in the same lane as the host vehicle and the following vehicles that travel in the adjacent lanes (part 2).

FIG. 8C is a schematic view illustrating an example of display of the following vehicle that travels in the same lane as the host vehicle and the following vehicles that travel in the adjacent lanes (part 3).

FIG. 8D is a schematic view illustrating an example of display of the following vehicle that travels in the same lane as the host vehicle and the following vehicles that travel in the adjacent lanes (part 4).

### DESCRIPTION OF EMBODIMENTS

Hereinafter, an embodiment of the disclosure will be described in detail with reference to the drawings.

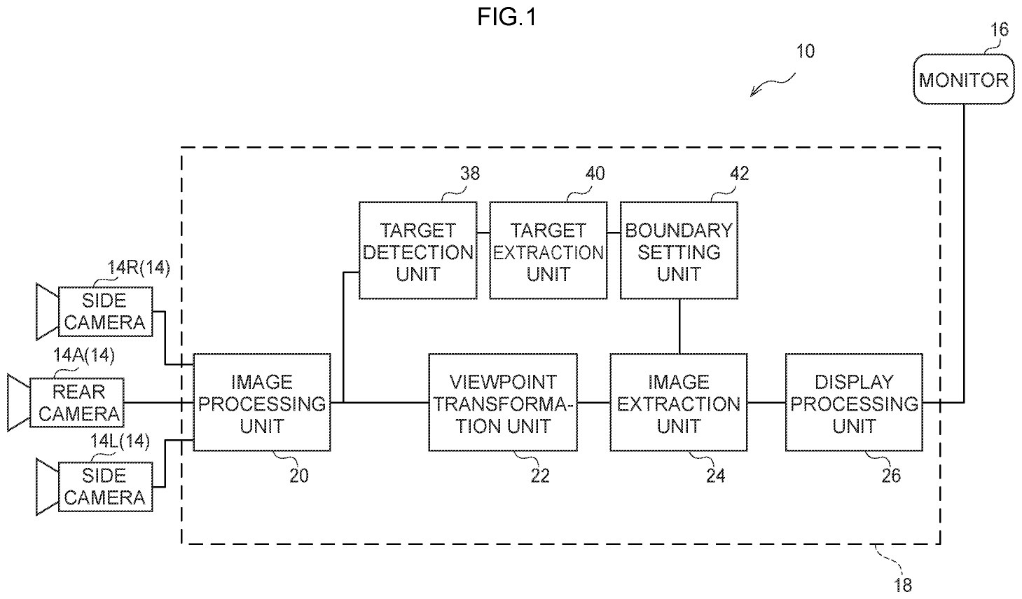

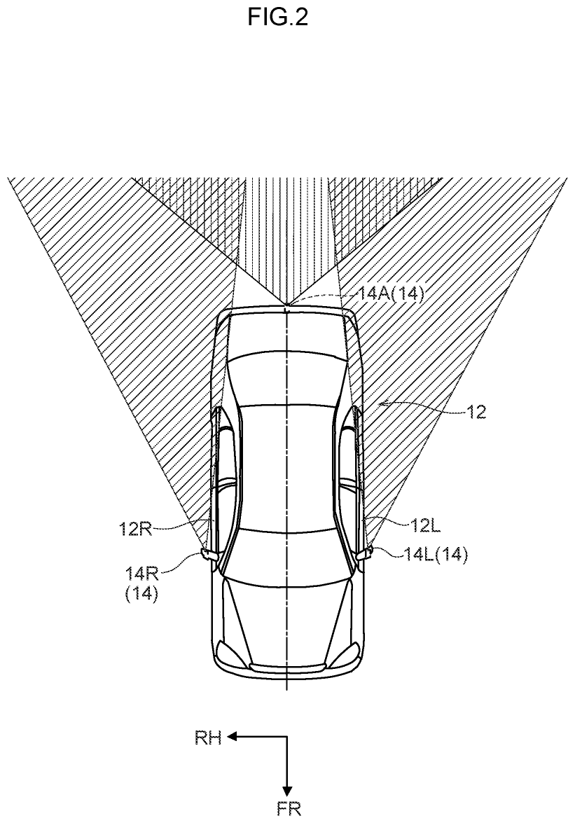

A vehicle visual recognition apparatus 10 according to the embodiment is provided in a vehicle 12 (host vehicle) and assists an occupant such as a driver to visually recognize the rear side of the vehicle. FIG. 1 is a block diagram illustrating a schematic configuration of the vehicle visual recognition apparatus 10 according to the embodiment. FIG. 2 is a plan view illustrating an outline of the vehicle 12 provided with the vehicle visual recognition apparatus 10 in a top view. In the drawings, a vehicle front side is indicated by an arrow FR, and a right side in a vehicle width direction is indicated by an arrow RH.

As illustrated in FIG. 1, the vehicle visual recognition apparatus 10 includes a plurality of cameras 14 as image capturing means constituting an image capturing unit, a monitor 16 as a display medium constituting a display unit, and a visual recognition processing device 18 that includes a display unit (display control unit) for displaying a rear image corresponding to captured images of the cameras 14 on the monitor 16.

A rear camera 14A as a first image capturing means and side cameras 14L and 14R as second image capturing means are used as the cameras 14, and the camera 14 captures an image (video) by an image capturing element. As illustrated in FIG. 2, the rear camera 14A is disposed at the rear part of the vehicle 12 and at the center part of the vehicle 12 in the vehicle width direction (for example, the center part of a rear bumper in the vehicle width direction), and captures an image of the rear of the vehicle 12 at a predetermined angle of view (image capturing region).

In the side cameras 14L and 14R, the side camera 14L is attached to a door 12L on the left side of the vehicle 12 in the vehicle width direction. The side camera 14R is attached to a door 12R on the right side of the vehicle 12 in the vehicle width direction. In a case in which the vehicle 12 includes a door mirror, the side cameras 14L and 14R may be attached to door mirrors (not illustrated) of the vehicle 12. The side cameras 14L and 14R may be attached on side surface sides of the vehicle body in the vehicle 12, and may be attached on a front fender or the like.

Each of the side cameras 14L and 14R captures an image of the rear of the vehicle from the side of the vehicle 12 (the outside of the side surface of the vehicle body) at a predetermined angle of view (image capturing region). The side cameras 14L and 14R are disposed such that a part of each of the image capturing regions overlaps the image capturing region of the rear camera 14A. Therefore, an image of the rear side of the vehicle 12 is captured at a wide angle over a range from the left oblique rear to the right oblique rear of the vehicle body including the immediate rear of both left and right sides of the vehicle body by the rear camera 14A and the side cameras 14L and 14R. As a result, in the vehicle visual recognition apparatus 10, the rear camera 14A and the side cameras 14L and 14R can capture images of almost the entire area from the left rear side to the right rear side of the vehicle body of the vehicle 12.

The monitor 16 has a thin rectangular shape elongated in the vehicle width direction. The monitor 16 is disposed near the upper part of a front windshield glass on the vehicle front side (at a position corresponding to an inner mirror) in the vehicle interior. In the monitor 16, a display surface faces the rear of the vehicle to enable visual recognition of the occupant in the vehicle interior. The monitor 16 displays the captured image of the camera 14 to function as the inner mirror. The monitor 16 may be provided on an instrument panel, and the monitor 16 can be provided at any position at which the occupant can easily visually recognize the monitor 16 without interfering with the visual recognition of the occupant.

The visual recognition processing device 18 performs control to combine (join) the captured images of the rear camera 14A and the side cameras 14L and 14R, generate a rear image (vehicle-exterior rear image) in which the rear of the vehicle appears at a wide angle, and display the generated rear image on the monitor 16. In the embodiment, as the rear image displayed on the monitor 16, an image obtained by joining (combining) display images extracted from the captured images of the rear camera 14A and the side cameras 14L and 14R is used. The vehicle visual recognition apparatus 10 may display an image of the vehicle interior captured by an interior camera on the monitor 16 in superimposition with the rear image.

The visual recognition processing device 18 includes a microcomputer (not illustrated) in which a CPU, a ROM, a RAM, a storage as a nonvolatile storage medium, an input/output interface, and the like are mutually connected to each other by a bus. In the visual recognition processing device 18, a program stored in the ROM, the storage, or the like is read by the CPU and executed while being loaded into the RAM, whereby a function corresponding to the program is realized. A graphic processing unit (GPU), not only the CPU, but also a field programmable gate array (FPGA), or the like can also be used for the visual recognition processing device 18.

As illustrated in FIG. 1, the visual recognition processing device 18 includes an image processing unit 20, a viewpoint transformation unit 22, an image extraction unit 24, and a display processing unit 26. In the visual recognition processing device 18, the CPU executes a predetermined program to function as the image processing unit 20, the viewpoint transformation unit 22, the image extraction unit 24, and the display processing unit 26.

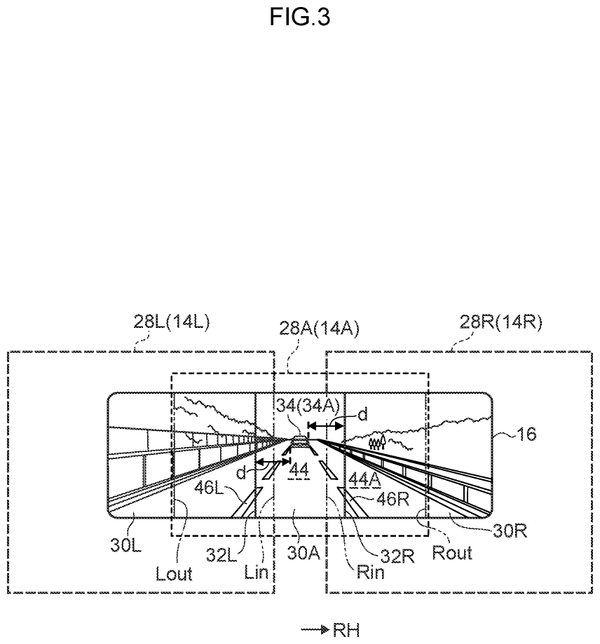

Each of the rear camera 14A, the side cameras 14L and 14R, and the monitor 16 is connected to the visual recognition processing device 18, and the visual recognition processing device 18 generates a rear image to be displayed on the monitor 16 from captured images of the rear camera 14A and the side cameras 14L and 14R. FIG. 3 is a schematic diagram illustrating an outline of the captured image and the rear image displayed on the monitor 16. The captured images are displayed on the monitor 16 in a manner that the captured images of the rear camera 14A and the side cameras 14L and 14R are horizontally reversed, and the captured images of the left and right side cameras 14L and 14R are replaced with each other (horizontally reversed as a whole).

As illustrated in FIG. 3, the image processing unit 20 reads captured images of the rear camera 14A and the side cameras 14L and 14R, and performs predetermined image processing to output a captured image (image data) 28A as a first captured image obtained by the rear camera 14A and captured images (image data) 28L and 28R as second captured images obtained by the side cameras 14L and 14R, respectively. The image processing unit 20 performs processing such that the sizes of the images of the same object are made similar among the captured images 28A, 28L, and 28R.

The viewpoint positions of the captured images 28A, 28L, and 28R are different between the rear camera 14A and the side cameras 14L and 14R. From this point, the viewpoint transformation unit 22 executes a viewpoint transformation process on the captured images 28A, 28L, and 28R. In the viewpoint transformation process, for example, a virtual viewpoint is set on the vehicle front side of the center position (the center position in the vehicle width direction and the vertical direction) of the monitor 16, and the captured images 28A, 28L, and 28R are converted into images viewed from the virtual viewpoint.

In the viewpoint transformation process, a virtual screen set as a virtual plane at a predetermined position behind the vehicle 12 is set together with the virtual viewpoint. The virtual screen may be set to a flat surface or a curved surface. In a case in which the monitor 16 is curved in a convex shape toward the rear of the vehicle, the virtual screen is preferably set to a curved surface (a concave curved surface as viewed from the vehicle 12) that is made convex toward the rear of the vehicle. In the viewpoint transformation process, any method of converting each of the captured images 28A, 28L, and 28R into an image projected onto the virtual screen as viewed from the virtual viewpoint can be applied.

As a result, since in the viewpoint transformation unit 22, the viewpoint transformation process is executed on the captured images 28A, 28L, and 28R by applying the same virtual viewpoint and virtual screen, in a case in which the same object appears on not only the captured images 28A and 28L, but also the captured image 28A or the captured image 28R, the target is viewed in an overlapping manner.

The image extraction unit 24 extracts display images 30A, 30L, 30R to be displayed on the monitor 16 from the captured images 28A, 28L, 28R, respectively. The visual recognition processing device 18 sets, as an image boundary 32, an image boundary 32L between the captured image 28A and the captured image 28L and an image boundary 32R between the captured image 28A and the captured image 28R. The image extraction unit 24 executes a trimming process on each of the captured images 28A, 28L, and 28R in accordance with the image boundary 32 (image boundaries 32L and 32R) and a display region area on the monitor 16. As a result, the image extraction unit 24 extracts the display image 30A as a first display image from the captured image 28A, and extracts the display images 30L and 30R as second display images from the captured images 28L and 28R.

The image boundaries 32L and 32R are made to have a substantially linear shape or a substantially band-like shape (a band shape having a width corresponding to a predetermined number of pixels) in the vertical direction. The image extraction unit 24 changes a trimming position in each of the captured images 28A, 28L, and 28R and extracts the display images 30A, 30L, and 30R, by moving (changing) the positions of the image boundaries 32L and 32R in the vehicle width direction. The image boundaries 32L and 32R correspond to the boundaries between the display images 30A and 30L and between the display images 30A and 30R on the virtual screen. The boundary between the display image 30A and the display image 30L and the boundary between the display image 30A and the display image 30R on the virtual screen are moved in the vehicle width direction by moving the image boundaries 32L and 32R.

The image boundary 32L is set in the overlapping region between the captured image 28A and the captured image 28R, and the image boundary 32R is set in the overlapping region between the captured image 28A and the captured image 28R. Each of the image boundaries 32L and 32R (the image boundary 32L and the image boundary 32R) is set in a range from a position (positions Lin and Rin) on an inner side in the vehicle width direction to a position (positions Lout and Rout) on an outer side in the vehicle width direction. That is, the position of the image boundary 32L is set in the range of the positions from Lin to Lout, and the position of the image boundary 32R is set in the range of the positions from Rin to Rout.

The display image 30A is narrowest in the vehicle width direction by setting the image boundaries 32L and 32R to the positions Lin and Rin on the inner side in the vehicle width direction, and is widest in the vehicle width direction by setting the image boundaries 32L and 32R to the positions Lout and Rout on the outer side in the vehicle width direction.

The display processing unit 26 generates a rear image (image data of the rear image) to be displayed on the monitor 16 by joining the display image 30L and the display image 30R to the display image 30A at the image boundaries 32L and 32R on the left and right sides of the display image 30A. As a result, the rear image displayed on the monitor 16 is a combined image in which the display images 30A, 30L, and 30R are joined at the image boundaries 32L and 32R.

In general, a region (so-called blind spot) occurs near the image boundary 32R (the same applies to the image boundary 32L). The blind spot is a region in which an image does not appear in the combined image obtained by joining the display image 30A and the display image 30R trimmed at the image boundary 32R although the image appears in at least one of the captured images 28A and 28R. That is, in a case in which trimming is performed at the image boundary 32R by projection onto the virtual screen, an image of an object (or a part of the object) on the outer side in the vehicle width direction (captured image 28R side) from the image boundary 32R is removed from the captured image 28A (display image 30A) among objects on the viewpoint side (camera 14 side) closer than the virtual screen, and an image of an object (or a part of the object) on the inner side (captured image 28A side) from the image boundary 32R is removed from the captured image 28R (display image 30R). Therefore, the captured images 28A and 28R are trimmed at the image boundary 32R, and a region removed by trimming serves as a blind spot (blind spot region) in the rear image obtained by combining the display images 30A and 30R.

In the vehicle visual recognition apparatus 10, in a case in which the image boundaries 32L and 32R are located at the positions Lout and Rout on the outer side in the vehicle width direction, regions far from the vehicle body in the captured images 28L and 28R are extracted in the display images 30L and 30R. Therefore, in the rear image displayed on the monitor 16, the blind spot occurring on the side of the vehicle body becomes large (wide).

In the vehicle visual recognition apparatus 10, in a case in which the positions of the image boundaries 32L and 32R are respectively moved from the positions Lout and Rout to predetermined positions on the sides of the positions Lin and Rin (inner side in the vehicle width direction), blind spots are gradually narrowed, and the blind spots on the left rear side and the right rear side immediately near the vehicle body are narrowest.

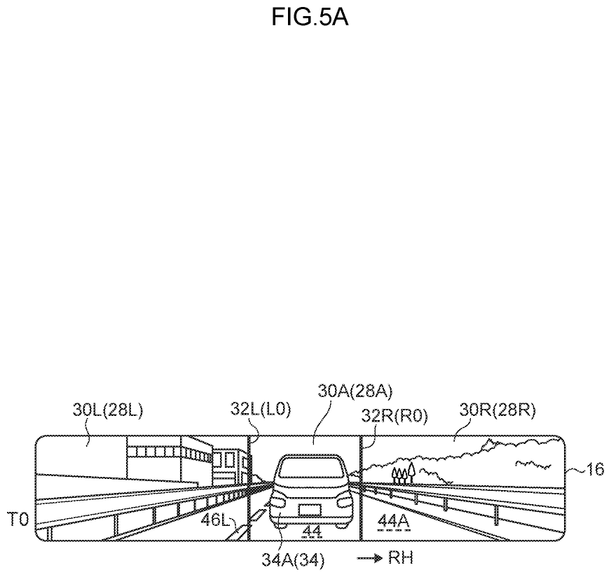

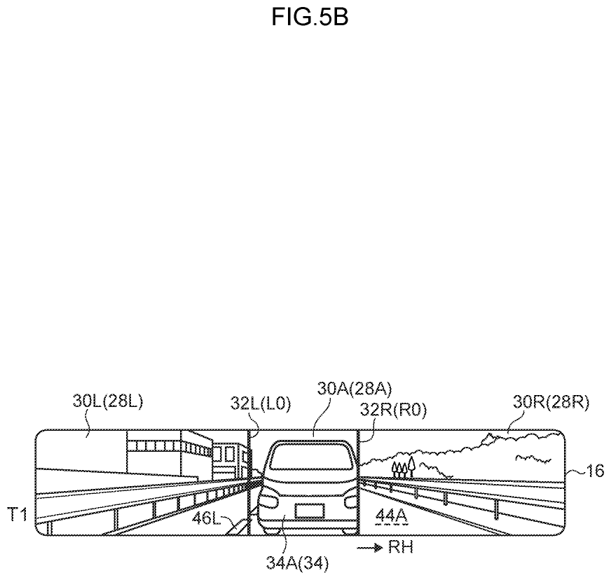

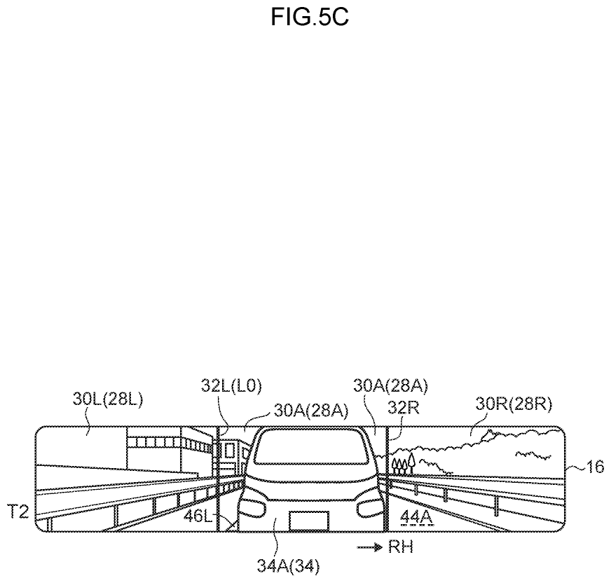

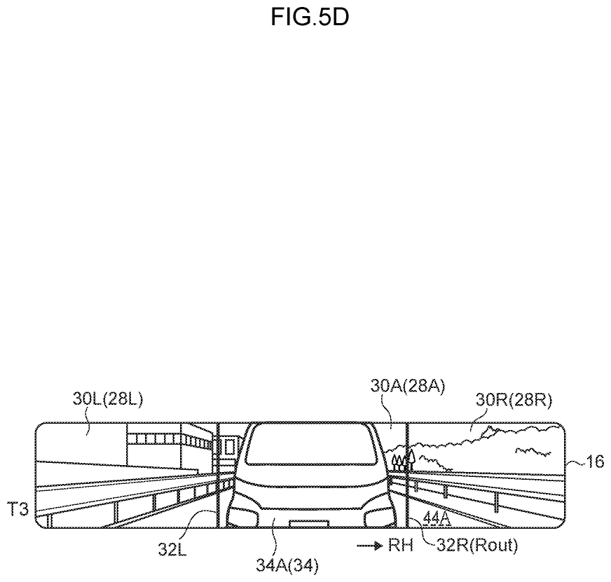

Here, in the vehicle visual recognition apparatus 10, standard positions (original positions, default positions, for example, positions illustrated in FIG. 5) LO and RO of the image boundaries 32L and 32R are set. Each of the standard positions LO and RO of the image boundaries 32L and 32R is set to a position where the blind spot of each of the left rear and the right rear immediately near the vehicle body is narrowest in the rear image (see FIG. 3). As a result, in the rear image displayed on the monitor 16, the image boundaries 32L and 32R are set to the standard positions LO and RO, whereby an occurrence of a situation in which the vicinity of the side of the vehicle body acts as a blind spot is suppressed.

In the vehicle visual recognition apparatus 10, an image of a vehicle (following vehicle) that travels behind the vehicle 12 is captured, and the vehicle behind the vehicle 12 is displayed on the monitor 16. In the vehicle visual recognition apparatus 10, the image of the following vehicle is included in any of the display images 30A, 30L, and 30R and displayed on the monitor 16, and thus the occupant can visually recognize the following vehicle.

The vehicle visual recognition apparatus 10 is provided with a target detection means. The target detection means detects a following vehicle that travels behind the vehicle 12. A method of using a millimeter wave radar that can measure the position and distance of an object by using a radio wave called millimeter wave having a frequency of from 30 GHz to 300 GHz can be applied to the target detection means. A known method such as a light detection ranging (LiDAR) method of measuring an irradiation direction of light and a time until light reflected by an object is received, by using light (laser light) such as infrared light, can be applied to the target detection means.

The vehicle visual recognition apparatus 10 is provided with the rear camera 14A and the side cameras 14L and 14R as image capturing means, and at least some image capturing regions overlap (overlap) each other between the rear camera 14A and the side cameras 14L and 14R. From this point, in a case in which a following vehicle 34 and a distance (inter-vehicle distance) of the following vehicle from the vehicle 12 are detected together, a stereo camera type may be applied.

In the embodiment, a following vehicle (referred to as a following vehicle 34 below) that travels immediately behind the vehicle 12 is applied as a detection target of the target detection means, and the following vehicle 34 as the target travels behind (mainly immediately behind) the vehicle 12, thereby being captured by the rear camera 14A.

The target detection means only needs to be able to detect at least the following vehicle 34. In the embodiment, the target detection means detects the following vehicle 34 by using the captured image 28A obtained by the rear camera 14A. A plurality of methods may be applied to the target detection means. For example, the captured image 28A of the rear camera 14A and the millimeter wave radar method can be used in combination, or the captured image 28A of the rear camera 14A and the LiDAR method can be used in combination, whereby the detection accuracy can be improved.

In the visual recognition processing device 18 of the vehicle visual recognition apparatus 10, a target detection unit 38 constituting the target detection means, a target extraction unit 40 as the target detection means, and a boundary setting unit 42 as a setting means are formed. In the visual recognition processing device 18, the CPU executes a predetermined program to function as the target detection unit 38, the target extraction unit 40, and the boundary setting unit 42.

The target detection unit 38 reads the captured image 28A of the rear camera 14A and the captured images 28L and 28R of the side cameras 14L and 14R, searches for an image of following vehicle 34 (a vehicle image 34A) from the captured image 28A, and detects the following vehicle 34 appearing in the captured image 28A. In order to detect the following vehicle 34, various known methods such as a pattern matching method of searching for an image of a pattern approximate to a plurality of pattern images stored in advance for the vehicle (following vehicle) can be applied.

The target extraction unit 40 reads the captured image 28A of the rear camera 14A and the captured images 28L and 28R of the side cameras 14L and 14R, and extracts a position (contour and contour region) of the vehicle image 34A of the following vehicle 34 detected by the target detection unit 38 on the captured image 28A. At this time, in a case in which a plurality of following vehicles 34 are detected, the target extraction unit 40 detects the following vehicle 34 closest to the vehicle 12 as the object.

White lines (lane lines) 46L and 46R are marked on the left and right sides of a lane 44 on a road on which the vehicle 12 travels, and the rear camera 14A and the side cameras 14L and 14R capture images of the rear of the vehicle including the lane 44 (white lines 46L and 46R) (see FIG. 3). From this point, regarding determination as to whether or not the vehicle detected by the target detection unit 38 is set as a target following vehicle 34, the white lines 46L and 46R indicating the lanes 44 on the captured images 28A, 28L, and 28R are extracted, and, in a case in which it can be regarded that the following vehicle travels in the same lane 44 as the vehicle 12, this vehicle can be determined to be the following vehicle 34.

An image capturing range of the rear camera 14A is determined in advance with respect to the center line of the vehicle 12 in the vehicle width direction. For example, the center position in the vehicle width direction on the captured image 28A overlaps the center line of the vehicle 12. From this point, in the determination as to whether or not the vehicle detected by the target detection unit 38 is set as the target following vehicle 34, in a case in which the size of the image of the following vehicle on the captured image 28A is equal to or larger than a predetermined value, and the center position of the image of the following vehicle in the vehicle width direction on the captured image 28A is within a predetermined range (for example, within a range that can be regarded as traveling in the same lane 44) with respect to the center position of the captured image 28A, this vehicle can be set as the following vehicle 34.

In a case in which the following vehicle 34 as the target is set (specified), the boundary setting unit 42 sets the position of the image boundary 32L between the display image 30A and the display image 30L and the position of the image boundary 32R between the display image 30A and the display image 30L, in accordance with the image position (the position of the vehicle image 34A) of the following vehicle 34 on the captured image 28A.

The boundary setting unit 42 sets the image boundaries 32L and 32R in the ranges of the positions from Lin to Lout and the positions from Rin to Rout, respectively. At this time, in a case in which another vehicle does not travel (does not appear) behind the vehicle 12, or another vehicle behind the vehicle 12 cannot be regarded as being immediately behind the vehicle 12 because the other vehicle travels in the adjacent lane, or the like, the boundary setting unit 42 sets the positions of the image boundaries 32L and 32R to the standard positions.

The boundary setting unit 42 sets the image boundaries 32L and 32R at the respective positions where it is not difficult to view the vehicle image 34A due to overlapping with the vehicle image 34A of the following vehicle 34. For example, in the boundary setting unit 42, the following vehicle 34 becomes closer, the vehicle image 34A displayed on the monitor 16 becomes larger, and a distance d between the vehicle image 34A and at least one of the image boundary 32L and the image boundary 32R becomes narrower.

In a case in which the distance d is equal to or less than a given distance dl that is a first distance (d≤d1), the boundary setting unit 42 sets the corresponding image boundary 32 (at least one of the image boundary 32L and the image boundary 32R) to move outward in the vehicle width direction (position Lout side, position Rout side) by a predetermined movement amount (predetermined distance corresponding to a predetermined number of pixels or the like on the monitor 16, referred to as a distance dsa below) set in advance. In a case in which the image boundary 32 (at least one of the image boundary 32L and the image boundary 32R) overlaps the vehicle image 34A of the following vehicle 34, the boundary setting unit 42 also sets the corresponding image boundary 32 to move outward in the vehicle width direction by the distance dsa.

The boundary setting unit 42 suppresses an occurrence of a situation in which the image boundaries 32L and 32R are located more outside in the vehicle width direction than necessary. For example, in a case in which the following vehicle 34 is far, the vehicle image 34A displayed on the monitor 16 becomes smaller, or the like, the distance d between the vehicle image 34A, and the image boundaries 32L and 32R increases. As a result, in a case in which the distance d is equal to or more than a distance d2 that is a second distance, the boundary setting unit 42 sets the positions of the image boundaries 32L and 32R so that the image boundaries 32L and 32R approach the standard positions LO and RO (to be on the inner side in the vehicle width direction). At this time, the boundary setting unit 42 sets the image boundaries 32L and 32R to move by a predetermined movement amount (predetermined distance corresponding to a predetermined number of pixels or the like on the monitor 16, referred to as a distance dsb below).

The distance d1, the distance d2, the distance dsa, and the distance dsb are set in advance within a range in which the visibility of the occupant and the appearance of the rear image are not impaired in the rear image displayed on the monitor 16. Dimensions (the number of pixels) between the center positions of the image boundaries 32L and 32R or the end parts of the image boundaries 32L and 32R on the vehicle image 34A side and the end parts of the vehicle image 34A in the vehicle width direction can be applied as the distance d, the distance dsa, and the like.

The image extraction unit 24 of the visual recognition processing device 18 extracts each of the display images 30A, 30L, and 30R from the captured images 28A, 28L, and 28R based on the image boundaries 32L and 32R set by the boundary setting unit 42. As a result, the rear image in which the display images 30A, 30L, and 30R are combined is displayed on the monitor 16.

Next, the operation of the embodiment will be described.

The vehicle visual recognition apparatus 10 starts an operation in a case in which an instruction to start image display on the monitor 16 is given, for example, in a case in which an ignition switch (IG switch) of the vehicle 12 is turned on, and ends the operation after a predetermined time elapses in a case in which an instruction to end the image display is given, for example, in a case in which the IG switch is turned off. In the vehicle visual recognition apparatus 10, in a case in which the instruction to start the operation is given, the rear camera 14A and the side cameras 14L and 14R are operated, and the visual recognition processing device 18 is operated, and thus the captured images of the rear camera 14A and the side cameras 14L and 14R are displayed on the monitor 16.

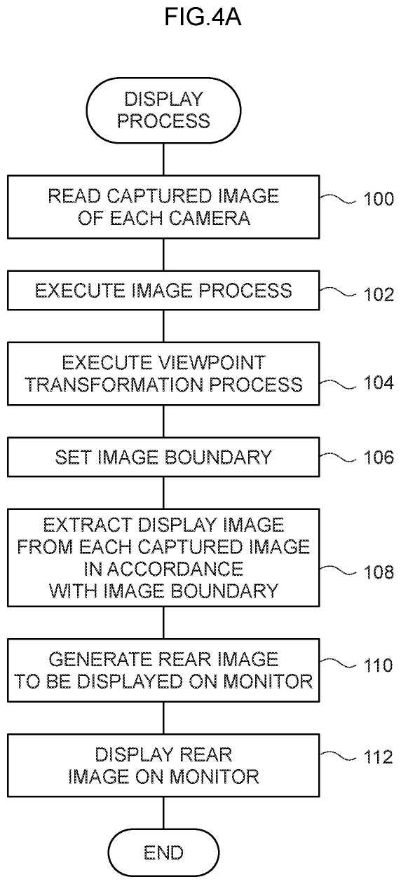

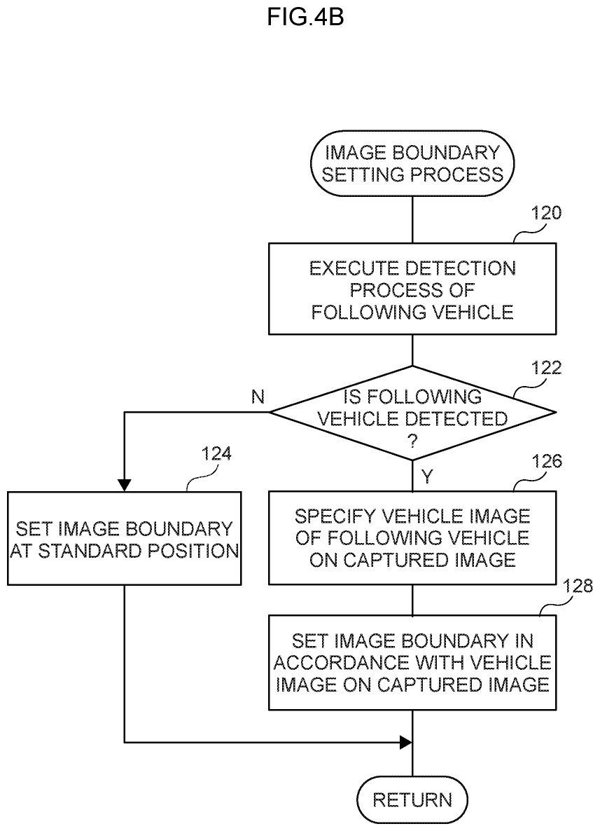

FIG. 4A is a flowchart illustrating an outline of a display process executed by operating the visual recognition processing device 18. FIG. 4B is a flowchart illustrating an example of an image boundary setting process. FIGS. 5A to 5D are schematic views illustrating display of the monitor 16 in accordance with the vehicle image 34A in a case in which the image of the following vehicle 34 of the vehicle 12 is captured in the captured image 28A as an example. The image boundaries 32L and 32R are set separately, but one of the image boundaries 32L and 32R may be set in accordance with the other of the set image boundaries 32L and 32R by setting the other of the image boundaries 32L and 32R.

The flowchart of FIG. 4A is executed at preset time intervals in a case in which the visual recognition processing device 18 is operated. In the first step 100, a predetermined image process is executed by reading the captured image of each camera 14 (rear camera 14A and side cameras 14L and 14R) (step 102). As a result, the captured image 28A of the rear of the vehicle and the captured images 28L and 28R of the rear from the side of the vehicle are acquired. In the next step 104, a predetermined viewpoint transformation process is executed on the captured images 28A, 28L, and 28R.

In step 106, the visual recognition processing device 18 sets the image boundary 32 (image boundaries 32L and 32R). In step 108, the visual recognition processing device 18 executes the trimming process on each of the captured images 28A, 28L, and 28R subjected to the viewpoint transformation process, in accordance with the set image boundaries 32L and 32R to extract the display images 30A, 30L, and 30R. Then, in step 110, the visual recognition processing device 18 generates the rear image to be displayed on the monitor 16 by joining the display images 30A, 30L, and 30R at the image boundaries 32L and 32R. In step 112, the visual recognition processing device 18 causes the rear image to be displayed on the monitor 16.

As a result, the rear image of the vehicle 12 obtained from the captured images 28A, 28L, and 28R of the rear camera 14A and the side cameras 14L and 14R is displayed as a moving image on the monitor 16 attached to the vehicle front side of the occupant in the vehicle interior, and the visual recognition of the rear of the vehicle by the occupant in the vehicle interior is assisted with the rear image displayed on the monitor 16. Moreover, the occupant can visually recognize a wide range from the rear on the left side of the vehicle to the rear on the right side of the vehicle.

In the vehicle visual recognition apparatus 10, the visual recognition processing device 18 detects the following vehicle 34 that travels behind (substantially immediately behind) the vehicle 12. In a case in which the following vehicle 34 is detected, the visual recognition processing device 18 sets the image boundaries 32L and 32R in accordance with the vehicle image 34A of the following vehicle 34. As a result, in the vehicle visual recognition apparatus 10, the vehicle image 34A is effectively displayed on the monitor 16.

The flowchart of FIG. 4B is executed by proceeding to step 106 in FIG. 4A. In the first step 120, the visual recognition processing device 18 detects the vehicle that travels behind the vehicle 12. In step 122, it is confirmed whether or not the following vehicle 34 that travels substantially immediately behind (the position regarded as being immediately behind) the vehicle 12 is detected. Since the following vehicle 34 is a vehicle captured by at least the rear camera 14A, the captured image 28A is used to detect the following vehicle 34, and the visual recognition processing device 18 searches the captured image 28A to detect the following vehicle 34 (vehicle image 34A of the following vehicle 34).

In a case in which the following vehicle 34 is not detected from the captured image 28A (including a case in which the following vehicle is much far rearward), the visual recognition processing device 18 makes a negative determination in step 122 and proceeds to step 124.

In step 124, the visual recognition processing device 18 sets the image boundaries 32 (image boundaries 32L and 32R) at the standard positions LO and RO, and then proceeds to the next process. As a result, normally, the rear image in which the image boundaries 32L and 32R are set to the standard positions LO and RO is displayed on the monitor 16 (not illustrated).

In the vehicle visual recognition apparatus 10, the standard positions LO and RO of the image boundaries 32L and 32R are set to positions where blind spots on the rear side near the side surface of the vehicle body of the vehicle 12 are narrowed. Therefore, since the blind spot is narrowed and the immediate vicinity of both the left and right sides and the immediate rear of both the left and right sides of the vehicle body are displayed on the monitor 16, an occurrence of a situation in which the immediate vicinity of the vehicle body and the rear of the immediate vicinity serve as blind spots in the rear image displayed on the monitor 16 is suppressed. As a result, in the vehicle visual recognition apparatus 10, it is possible to effectively assist the visual recognition of the rear of the occupant and the vicinity of the vehicle body.

In a case in which the following vehicle 34 that travels immediately behind the vehicle 12 (in the same lane as the vehicle 12) is detected, the visual recognition processing device 18 makes an affirmative determination in step 122 and proceeds to step 126. In step 126, the visual recognition processing device 18 specifies the vehicle image 34A of the following vehicle 34 in the captured image 28A in which the following vehicle 34 appears. That is, the position and the image range (image size) of the vehicle image 34A on the captured image 28A are specified.

In a case in which the vehicle image 34A of the following vehicle 34 on the captured image 28A is specified, the visual recognition processing device 18 sets the image boundary 32 (image boundaries 32L and 32R) in accordance with the vehicle image 34A in step 128. At this time, the image boundary 32 is located at least a position where the appearance of the vehicle image 34A of the following vehicle 34 is not impaired. The image boundary 32 is preferably set at a position that does not overlap the vehicle image 34A of following vehicle 34 (a position deviated from the vehicle image 34A).

For example, the image boundaries 32L and 32R are set at the positions that are on the outer side in a width direction (vehicle width direction) with respect to the vehicle image 34A of the following vehicle 34 on the captured image 28A (at the standard positions LO and RO or outside the standard positions LO and RO in the vehicle width direction). At this time, in a case in which the image boundaries 32L and 32R overlap the vehicle image 34A of the following vehicle 34, or in a case in which the distance d between the image boundaries 32L and 32R and the vehicle image 34A of the following vehicle 34 is equal to or less than the distance dl (d ≤ d1), the vehicle visual recognition apparatus 10 sets the position of the corresponding image boundary 32 to move outward in the vehicle width direction (a direction away from the standard positions LO, RO) by the distance dsa from the current position.

FIGS. 5A to 5D illustrate a case in which, while following vehicle 34 travels in the same lane 44 as the vehicle 12, the following vehicle 34 approaches the vehicle 12 at a time point TO (see FIG. 5A), a time point Tl (see FIG. 5B), a time point T2 (see FIG. 5C), and a time point T3 (see FIG. 5D) with the lapse of time (lapse of the time point T).

As illustrated in FIG. 5A, in a case in which the following vehicle 34 is relatively far from the vehicle 12, and the vehicle image 34A of the following vehicle 34 appearing in the captured image 28A (display image 30A) is relatively small and falls (does not overlap) between the image boundaries 32L and 32R at the standard positions LO and RO, the image boundaries 32L and 32R are set to the standard positions LO and RO, respectively.

In a case in which the following vehicle 34 approaches the vehicle 12, the vehicle image 34A displayed on the monitor 16 gradually becomes larger. As a result, as illustrated in FIG. 5B, in a case in which the vehicle image 34A becomes close to come into contact with the image boundaries 32L and 32R (for example, at least one of the distance d between the image boundary 32L and the vehicle image 34A and the distance d between the image boundary 32R and the vehicle image 34A is equal to or less than the distance dl (d ≤ dl)), the visual recognition processing device 18 sets the corresponding image boundary 32 (for example, the image boundary 32R) to move outward in the vehicle width direction by the distance dsa.

The visual recognition processing device 18 set each of the image boundaries 32L and 32R to move in accordance with the distance d from the vehicle image 34A, and may set the image boundaries 32L and 32R to move by a similar movement amount (the distance dsa) in parallel (at the same timing). In a case in which a change degree (a change amount per unit time) of the size of the vehicle image 34A is large, the image boundary 32 may be moved in accordance with the change degree such that the distance dsa at the time of movement is set to increase as compared with a case in which the change degree is small. As a result, it is possible to suppress an occurrence of a situation in which the position of the image boundary 32 frequently changes and the occupant feels annoyed.

As a result, as illustrated in FIG. 5C, the image boundary 32R is moved outward in the vehicle width direction by a predetermined amount (for example, the distance dsa). At this time, in a case in which the image boundary 32L does not satisfy a condition for movement, the position of the image boundary 32L is not changed and remains at the standard position LO. As a result, even in a case in which the following vehicle 34 further approaches the vehicle 12, it is possible to suppress an occurrence of a situation in which the image boundary 32 overlaps the vehicle image 34A and the appearance of the vehicle image 34A is impaired.

In a case in which the following vehicle 34 further approaches the vehicle 12 and the vehicle image 34A becomes larger, for example, the vehicle image 34A overlaps the image boundaries 32L and 32R, or the distance d between the vehicle image 34A and the image boundaries 32L and 32R becomes equal to or less than the distance dl. In this case, the visual recognition processing device 18 sets each of the image boundaries 32L and 32R to move further outward in the vehicle width direction by the distance dsa, for example.

As a result, as illustrated in FIG. 5D, the image boundary 32L is set to move from the standard position LO toward the position Lout, and the image boundary 32R is set to move to a position (for example, the position Rout) further far from the vehicle image 34A. As a result, the image boundaries 32L and 32R are far from the vehicle image 34A, and an occurrence of a situation in which the image boundaries 32L and 32R deteriorate the visibility to the following vehicle 34 by the occupant is suppressed.

In a case in which the following vehicle 34 moves far from the vehicle 12, the vehicle image 34A displayed on the monitor 16 gradually becomes smaller, and the distance d between the vehicle image 34A and the image boundary 32 increases (widens). In the visual recognition processing device 18, in a case in which the distance d between the image boundary 32 and the vehicle image 34A becomes equal to or more than the distance d2, the corresponding image boundary 32 is moved inward in the vehicle width direction by the distance dsb. As a result, as the vehicle image 34A becomes smaller, the image boundaries 32L and 32R are moved (set) to approach the standard positions LO and RO. That is, in the visual recognition processing device 18, the image boundaries 32L and 32R far from the standard positions LO and RO are moved toward the standard positions LO and RO stepwise (or may be continuously) until reaching the standard positions LO and RO.

As described above, in the vehicle visual recognition apparatus 10, in the rear image displayed on the monitor 16, it is possible to suppress overlapping with the vehicle image 34A of the following vehicle 34 at the image boundary 32, and to suppress the difficulty in viewing the vehicle image 34A. As a result, in the vehicle visual recognition apparatus 10, it is possible to effectively suppress the deterioration in the visibility to the following vehicle 34 displayed on the monitor 16 and to effectively assist the rear visual field of the occupant.

The vehicle visual recognition apparatus 10 extracts the display images 30A, 30L, and 30R from the captured images 28A, 28L, and 28R of the rear camera 14A and the side cameras 14L and 14R, respectively, and generates the rear image to be displayed on the monitor 16. At this time, the vehicle visual recognition apparatus 10 detects the vehicle image 34A of the following vehicle 34 from the captured image 28 A, and sets the image boundary 32 not to overlap the vehicle image 34A displayed on the monitor 16.

As a result, the vehicle visual recognition apparatus 10 suppresses the overlapping of the image boundary 32 with the vehicle image 34A in the rear image displayed on the monitor 16. Thus, it is possible to suppress the deterioration in visibility to the vehicle image 34A (following vehicle 34) displayed on the monitor 16. In addition, it is possible to assist the visual recognition of the following vehicle 34 by the occupant while suppressing deterioration in appearance due to overlapping of the image boundary 32 with the vehicle image 34A of the following vehicle 34.

The vehicle visual recognition apparatus 10 detects the following vehicle 34 (vehicle image 34A) from the captured image 28A of the rear camera 14A. Thus, it is possible to efficiently detect the following vehicle 34 without providing a detection means for detecting the following vehicle 34 separately from the image capturing means.

In a case in which the image boundary 32 is set to move in accordance with the vehicle image 34A of the following vehicle 34, the vehicle visual recognition apparatus 10 suppress an occurrence of a situation in which the vehicle image 34A and the image boundary 32 are much far away from each other. As a result, in the vehicle visual recognition apparatus 10, it is possible to suppress an increase in the blind spot due to the image boundaries 32 (the image boundaries 32L and 32R) being too far from the standard positions LO and RO, so that it is possible to reliably assist the visual recognition of the occupant.

In the above description, the image boundaries 32L and 32R are set (moved) in the range from the standard positions LO and RO to the positions Lout and Rout so that the image boundaries 32L and 32R do not overlap the vehicle image 34A. At this time, the image boundaries 32L and 32R are set not to be too far from or too close to the vehicle image 34A. However, even in a state where the image boundaries 32L and 32R overlap the vehicle image 34A, in a case in which the image boundaries 32L and 32R overlap the vehicle image 34A a little, the influence on visibility and appearance is small.

For example, in a case in which the image boundary 32 overlaps the vehicle image 34A, the image size of the vehicle image 34A (the vehicle image 34A of the display image 30A) displayed on the monitor 16 (for example, the dimension of the vehicle image 34A in the vehicle width direction. The image area of the vehicle image 34A may be used) is changed.

From this point, it is possible to determine whether or not the image boundary 32 is moved from the proportion of the image size of the vehicle image 34A on the display image 30A to the image size of the vehicle image 34A on the captured image 28A for the vehicle image 34A of the following vehicle 34. In this case, in the rear image displayed on the monitor 16, a proportion (threshold value) at which it may be determined that the visibility of the occupant and the appearance of the rear image are not impaired even in a case in which the image boundary 32 overlaps the vehicle image 34A is set in advance. In the vehicle visual recognition apparatus 10, this threshold value may be changeable.

The vehicle visual recognition apparatus 10 acquires the image size of the vehicle image 34A in the captured image 28A of the rear camera 14A and acquires the image size of the vehicle image 34A in the display image 30A. The vehicle visual recognition apparatus 10 calculates the proportion of the image size of the vehicle image 34A in the display image 30A to the image size of the vehicle image 34A in the captured image 28A of the rear camera 14A. Thereafter, the vehicle visual recognition apparatus 10 newly sets the image boundary 32 in a case in which the calculated proportion is equal to or less than the threshold value.

As a result, the calculated proportion becomes equal to or less than the threshold value and thus the image boundary 32 is set, so that it is possible to suppress an occurrence of a situation in which the vehicle image 34A is largely omitted in the rear image displayed on the monitor 16 or the image boundary 32 bothers the occupant. In addition, it is possible to assist the visual recognition of the occupant by the rear image displayed on the monitor 16.

The vehicle that travels behind the vehicle 12 is not limited to the vehicle that travels in the same lane 44 as the vehicle 12, and includes a vehicle that travels in a lane adjacent to the lane 44 of the vehicle 12, a vehicle that travels across the lane 44 and the adjacent lane, and the like.

The determination as to whether or not the following vehicle is the following vehicle 34 that travels immediately behind vehicle 12 (same lane 44) may be determined from an image on the captured image 28A of the rear camera 14A. In this case, for example, even in a case in which the following vehicle approaches the vehicle 12 and it is difficult to view the white lines 46L and 46R, it is possible to accurately determine whether or not the following vehicle is the following vehicle 34, and it is possible to suppress an occurrence of a situation in which the appearance of the vehicle image 34A of the following vehicle 34 is impaired by the image boundaries 32L and 32R.

A following vehicle (referred to as a following vehicle 48 below) closer to the vehicle 12 than the following vehicle 34 in the same lane 44 as the vehicle 12 may travel on a road in which the lane 44 is divided into a plurality of lanes.

Here, a case in which the following vehicle 34 and the following vehicle 48 of the vehicle 12 travel will be described as a modification example of the setting process of the image boundary 32 in the vehicle visual recognition apparatus 10.

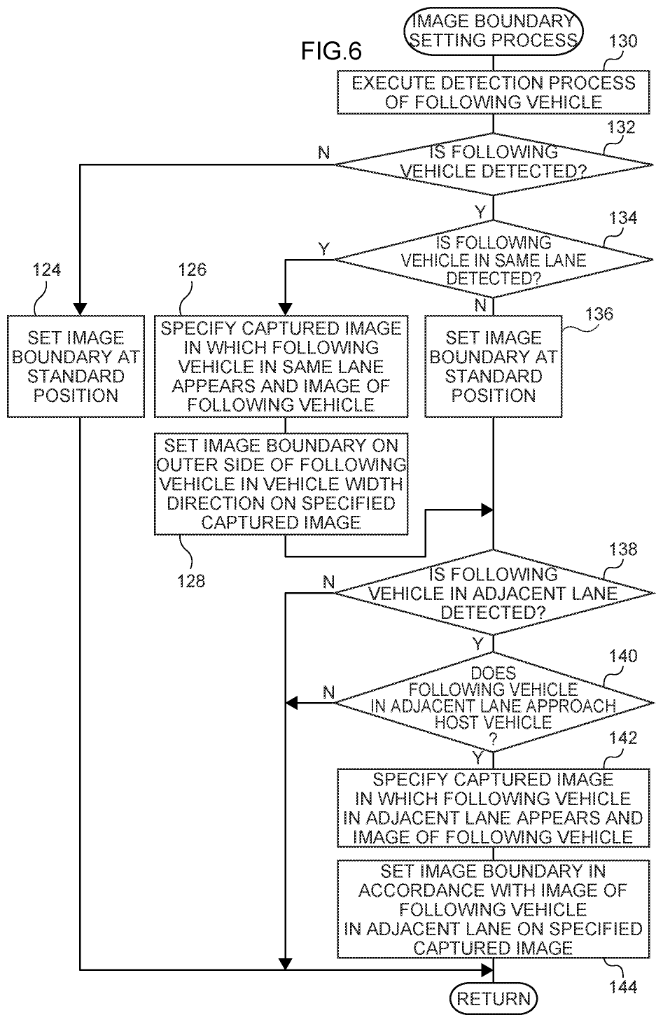

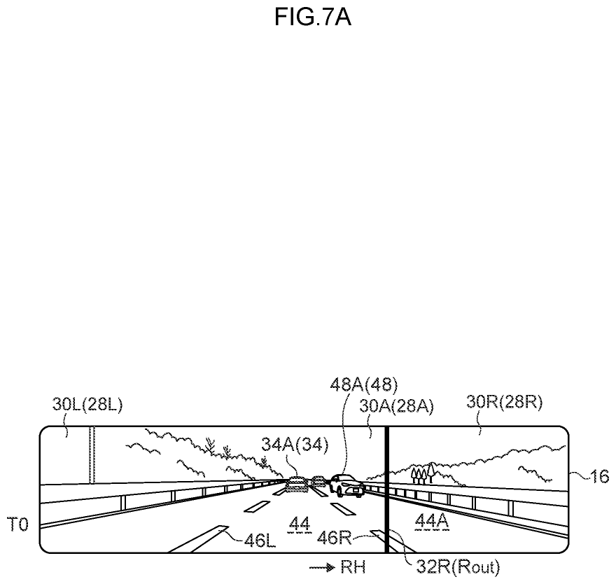

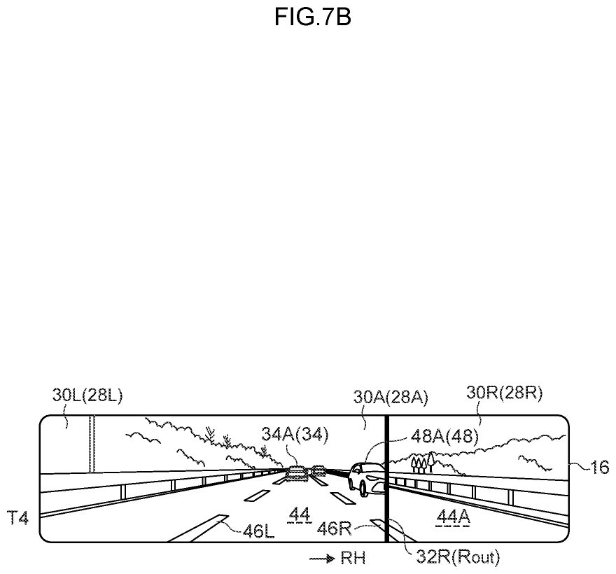

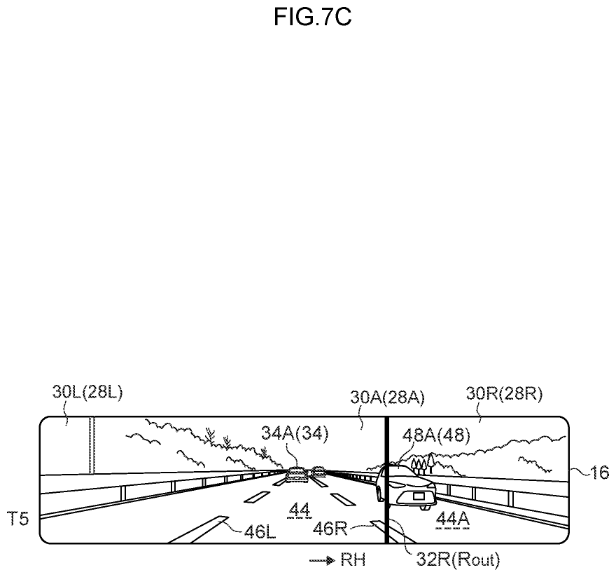

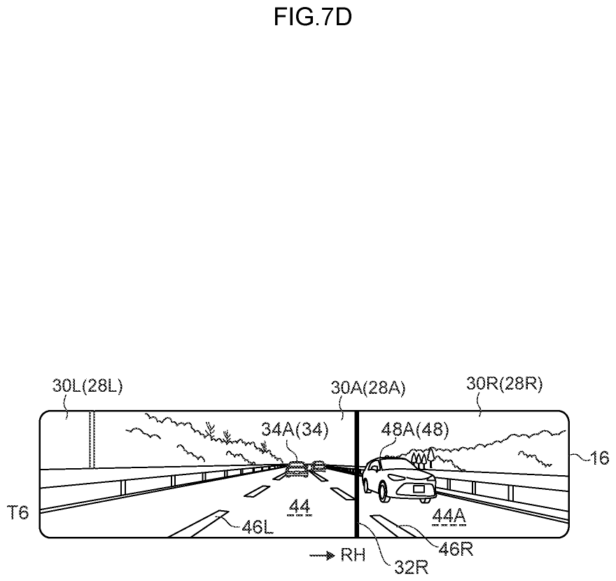

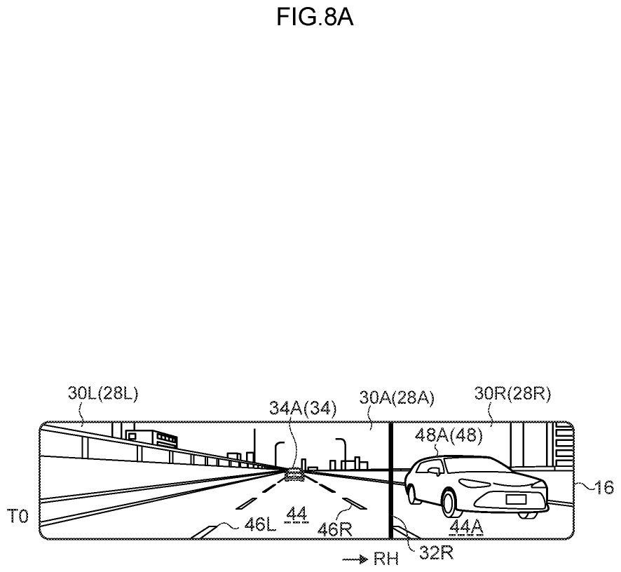

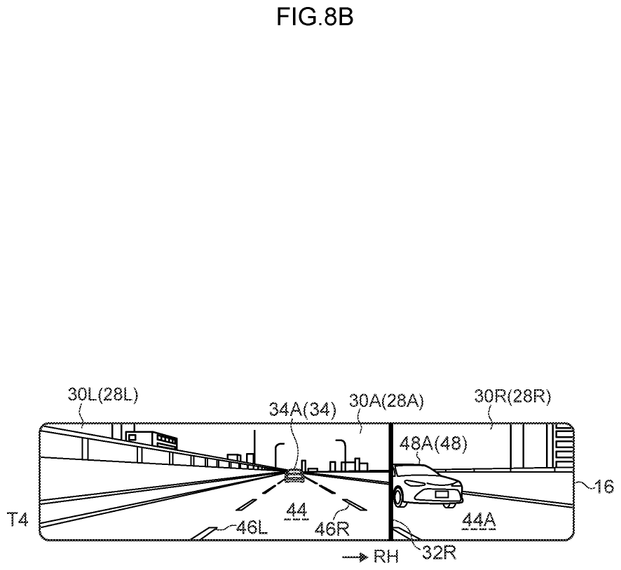

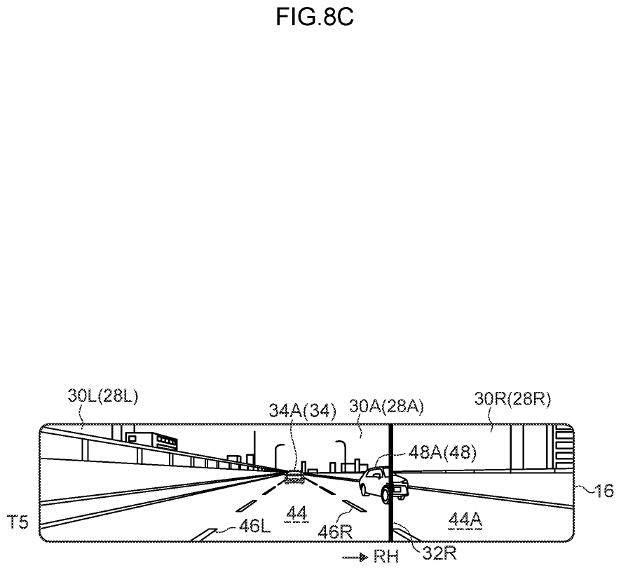

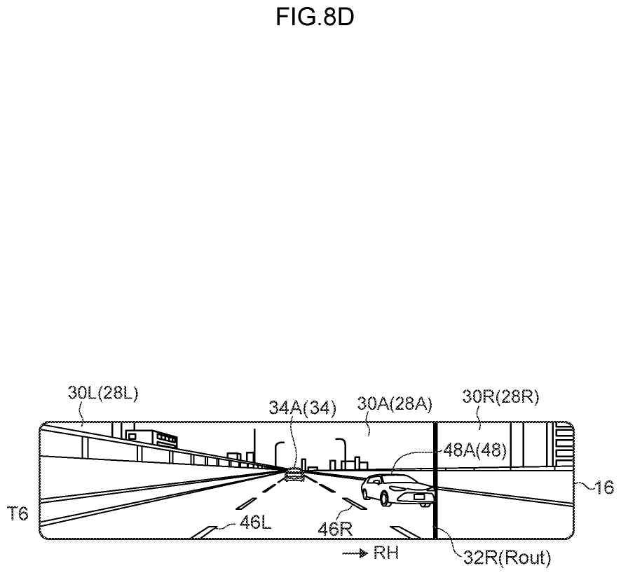

FIG. 6 is a flowchart illustrating an example of an image boundary setting process according to a modification example. FIGS. 7A to 7D and FIGS. 8A to 8D schematically illustrate displays on the monitor 16 in a case in which the following vehicle 34 travels in the same lane 44 as the vehicle 12 and the following vehicle 48 travels in an adjacent (right adjacent) lane 44A of the vehicle 12.

The captured images 28L and 28R are used to detect the following vehicle 48 (detect a vehicle image 48A of the following vehicle 48). In FIG. 6, the same step numbers (reference signs) as the step numbers in FIG. 4B are assigned to the same processes as the processes in FIG. 4B, and the detailed description thereof will be omitted. In the modification example, the setting of one image boundary 32R will be described, and the illustration and description of the other image boundary 32L will be omitted. The other image boundary 32L may be set in accordance with the image boundary 32R.

FIG. 6 is used instead of FIG. 4B, and is executed by proceeding to step 106 in FIG. 4A. In the first step 130 of the flowchart of FIG. 6, the visual recognition processing device 18 executes a detection process of a following vehicle (following vehicles 34 and 48) that travels behind the vehicle 12 from the captured images 28A and 28R of the rear camera 14A and the side camera 14R (which may include the captured image 28L of the side camera 14L). The vehicle visual recognition apparatus 10 confirms whether or not the following vehicle (at least one of the following vehicle 34 and the following vehicle 48) is detected in step 132, and confirms whether or not the following vehicle 34 that travels in the same lane 44 as the vehicle 12 is detected in step 134.

In the detection of the following vehicle 34 and the following vehicle 48, the visual recognition processing device 18 specifies the left and right white lines 46L and 46R of the lane 44 in which the vehicle 12 travels and the lanes 44 and 44A from the captured images 28A and 28R. The visual recognition processing device 18 specifies a vehicle that travels in the lane 44 (between the white lines 46L and 46R) as the following vehicle 34, and specifies a vehicle that travels in the lane 44A on an opposite side of the lane 44 with the white line 46R interposed between the lane 44 and the lane 44A, as the following vehicle 48.

Here, in a case in which none of the following vehicles 34 and 48 is detected (including a case in which the following vehicles are much far from each other), the visual recognition processing device 18 makes a negative determination in step 132 and proceeds to step 124. As a result, each image boundary 32R is set to the standard position RO.

In a case in which the detected vehicles include the following vehicle 34 that travels in the lane 44, the visual recognition processing device 18 makes an affirmative determination in step 132, makes an affirmative determination in step 134, and proceeds to step 126. The visual recognition processing device 18 sequentially executes step 126 and step 128, sets the image boundary 32R based on the traveling state of the following vehicle 34, and proceeds to step 138. As a result, the visual recognition processing device 18 sets the image boundary 32R in a range of the standard position from RO to the position Rout in accordance with the vehicle image 34A of the following vehicle 34.

In a case in which the following vehicle 34 is not detected, the visual recognition processing device 18 makes a negative determination in step 134, proceeds to step 136, sets the image boundary 32R to the standard position RO, and proceeds to step 138. In step 138, the visual recognition processing device 18 confirms whether or not the following vehicle 48 (the vehicle image 48A of the following vehicle 48) that travels in the adjacent lane 44A is detected. In step 140, the visual recognition processing device 18 confirms whether or not the following vehicle 48 in the lane 44A is closer to the vehicle 12 than the following vehicle 34. At this time, in a case in which the following vehicle 48 is not detected, the visual recognition processing device 18 makes a negative determination in step 138 and starts the next process. In a case in which the following vehicle 48 is farther from the vehicle 12 than the following vehicle 34, the visual recognition processing device 18 makes an affirmative determination in step 138, makes a negative determination in step 140, and proceeds to the next process.

On the other hand, in a case in which the following vehicle 48 is closer to the vehicle 12 than the following vehicle 34, the vehicle image 48A of the following vehicle 48 is displayed on the monitor 16 to be larger than the vehicle image 34A of the following vehicle 34. In this case, the visual recognition processing device 18 makes an affirmative determination in each of step 138 and step 140, and proceeds to step 142. In step 142, the visual recognition processing device 18 specifies the captured image in which the entire width of the following vehicle 48 appears, and sets the position of the image boundary 32R not to overlap the vehicle image 48A of the following vehicle 48 on the specified captured image. At this time, in a case in which the ratio of the vehicle image 48A of the following vehicle 48 appearing in the captured image 28A is large in a state of appearing in the captured image 28A or appearing across the captured images 28A and 28R, the visual recognition processing device 18 specifies the captured image 28A as the captured image in which the following vehicle 48 appears. In a case in which the proportion of the vehicle image 48A of the following vehicle 48 appearing in the captured image 28R is large in a state of appearing in the captured image 28R or appearing across the captured images 28A and 28R, the visual recognition processing device 18 specifies the captured image 28R as the captured image in which the following vehicle 48 appears.

In the next Step 144, the visual recognition processing device 18 sets the image boundary 32R in accordance with the specified captured image (the vehicle image 48A on the captured image). At this time, in a case in which the captured image 28A is specified as the captured image, the visual recognition processing device 18 sets the image boundary 32R to the position on the outside of the standard position RO in the vehicle width direction (for example, the position Rout). In a case in which the captured image 28R is specified as the captured image, the visual recognition processing device 18 sets the image boundary 32R to the standard position RO.

By setting the image boundary 32R in this manner, in a case in which the following vehicle 48 is closer to the vehicle 12 than the following vehicle 34, the image boundary 32R changes as illustrated in FIGS. 7A to 7D or FIGS. 8A to 8D. FIGS. 7A to 7D and FIGS. 8A to 8D illustrate a case in which the traveling position of the following vehicle 48 changes with the lapse of time from the time point TO (see FIGS. 7A and 8A), the time point T4 (see FIGS. 7B and 8B), the time point T5 (see FIGS. 7C, 8C), and the time point T6 (see FIGS. 7D, 8D).

FIGS. 7A to 7D illustrate a case in which the following vehicle 48 approaches the vehicle 12. As illustrated in FIGS. 7A to 7C, in a case in which the following vehicle 48 is relatively far from the vehicle 12 and the vehicle image 48A of the following vehicle 48 displayed on the monitor 16 is relatively small (in a case in which the vehicle image 48A is located on the captured image 28A), the image boundary 32R is set to the position on the outside of the standard position RO in the vehicle width direction (for example, the position Rout), and the vehicle image 48A of the following vehicle 48 is displayed in the display image 30A. On the other hand, as illustrated in FIG. 7D, in a case in which the following vehicle 48 approaches the vehicle 12 and the vehicle image 48A of the following vehicle 48 displayed on the monitor 16 becomes relatively large (in a case in which the vehicle image 48A is located on the captured image 28R), the image boundary 32R is moved to the standard position RO.

As a result, in the vehicle visual recognition apparatus 10, it is possible to suppress an occurrence of a situation in which the image boundary 32R is displayed on the monitor 16 in a state of overlapping the vehicle image 48A of the following vehicle 48 that approaches the vehicle 12. Therefore, it is possible to suppress an occurrence of a situation in which the image boundary 32R deteriorates (makes it difficult to view) the appearance of the vehicle image 48A of the following vehicle 48, and it is possible to effectively assist the rear visual recognition of the occupant. In addition, in a case in which the following vehicle 48 approaches the vehicle 12, the image boundary 32R is located at the standard position RO, and thus, in the rear image displayed on the monitor 16, the blind spot near the right rear side of the vehicle body is narrowed, and it is possible to effectively assist the visual recognition of the occupant.

In a case in which the following vehicle 48 moves far from the vehicle 12, as illustrated in FIGS. 8A to 8C, in a case in which the following vehicle 48 appears in the captured image 28R, the image boundary 32 is set on the inner side of the position Rout (the standard position RO side) in the vehicle width direction in the vehicle visual recognition apparatus 10. As a result, the rear image in which the vehicle image 48A of the following vehicle 48 is reflected in the display image 30R is displayed on the monitor 16. At this time, as illustrated in FIGS. 8B and 8C, even in a case in which the following vehicle 48 is far from the vehicle 12, the vehicle visual recognition apparatus 10 sets (holds) the image boundary 32R on the inner side of the position Rout in the vehicle width direction during a period in which the following vehicle 48 mainly appears in the captured image 28R.

On the other hand, as illustrated in FIG. 8D, in a case in which the following vehicle 48 is far from the vehicle 12 and appears in the captured image 28A, the vehicle visual recognition apparatus 10 sets the image boundary 32 to move to the position Rout side (or may be the position Rout). As a result, the rear image in which the vehicle image 48A of the following vehicle 48 is reflected in the display image 30A is displayed on the monitor 16. At this time, as illustrated in FIG. 8C, in a case in which the following vehicle 48 straddles the captured images 28A and 28R, the vehicle visual recognition apparatus 10 may hold the image boundary 32R on the inner side of the position Rout in the vehicle width direction.

As described above, in the modification example, the vehicle visual recognition apparatus 10 can effectively suppress overlapping of each of the vehicle images 34A and 48A of the following vehicles 34 and 48 with the image boundary 32R. As a result, it is possible to suppress the deterioration in appearance due to overlapping of the image boundary 32 with the vehicle images 34A and 48A of the following vehicles 34 and 48, and it is possible to suppress the deterioration in visibility for the occupant. Thus, it is possible to effectively assist the visual recognition of the following vehicles 34 and 48 by the occupant.

The disclosure of Japanese Patent Application No. 2021-136228 filed on Aug. 24, 2021 is incorporated herein by reference in its entirety.

1. A vehicle visual recognition apparatus comprising:
an image capturing unit that includes a first image capturing means for outputting a first captured image obtained by capturing an image of a rear of a vehicle and a second image capturing means for outputting a second captured image obtained by capturing an image of a rear side of the vehicle from a side of a vehicle body such that a part of an image capturing region of the second image capturing means overlaps an image capturing region of the first image capturing means;
a display unit that sets, as a boundary, an image boundary set in an overlapping region between the first captured image and the second captured image, extracts a first display image from the first captured image and a second display image from the second captured image, in accordance with the image boundary, and displays a rear image obtained by joining the first display image and the second display image on a display medium so that the rear image is visible to an occupant;
a target detection means for detecting an image of a following vehicle of the vehicle, which is included in the first captured image; and
a setting means for setting the image boundary in accordance with an image position of the following vehicle such that the image of the following vehicle detected by the target detection means is disposed in the first display image.

2. The vehicle visual recognition apparatus according to claim 1, wherein the target detection means detects the following vehicle from the first captured image and the second captured image.

3. The vehicle visual recognition apparatus according to claim 1, wherein the setting means changes a position of the image boundary in a case in which a proportion of an image size of the following vehicle on the first display image in the rear image to an image size of the following vehicle on the first captured image is equal to or less than a proportion set in advance.

4. The vehicle visual recognition apparatus according to claim 1, wherein the setting means changes a position of the image boundary to move to a predetermined position outward in a vehicle width direction in a case in which a distance between the image of the following vehicle and the image boundary on the rear image is equal to or less than a first distance.

5. The vehicle visual recognition apparatus according to claim 1, wherein the setting means changes a position of the image boundary to move outward in a vehicle width direction by an amount set in advance in a case in which the position of the image boundary is moved.

6. The vehicle visual recognition apparatus according to claim 1, wherein the setting means changes a position of the image boundary to a standard position set in advance in the overlapping region in a case in which the image of the following vehicle is not detected on the first captured image.

7. The vehicle visual recognition apparatus according to claim 1, wherein the setting means changes a position of the image boundary to approach a standard position set in advance in the overlapping region in a case in which a distance between the image of the following vehicle and the image boundary is more than a second distance set in advance.

8. The vehicle visual recognition apparatus according to claim 7, wherein the setting means changes the position of the image boundary to be on an inner side in a vehicle width direction by an amount set in advance.
